(19) United States
(12) Patent Application Publication
(10) Pub. No.: US 2010/0236900 A1
(43) Pub. Date: Sep. 23, 2010

(54) Chain, Particularly Conveyor Chain for the Transport of Chassis Carriers or Unit Loads

(75) Inventor: Johannes Kremer, Eslohe (DE)

Correspondence Address: LERNER GREENBERG STEMER LLP, P O BOX 2480, HOLLYWOOD, FL, 33022-2480, US

(73) Assignee: KETTEN WULF BETRIEBS-GMBH, Eslohe-Kückelheim (DE)

(21) Appl. No.: 12/682,121

(22) PCT Filed: Oct. 2, 2008
(86) PCT No.: PCT/EP08/08379

§ 371 Date: Apr. 8, 2010

(30) Foreign Application Priority Data
Oct. 8, 2007 (DE) 10 2007 048 273.8

(51) Int. Cl. B65G 17/38

(52) U.S. Cl. 198/845

(57) ABSTRACT

A chain, in particular a conveyor chain for the transport of chassis carriers or bulk goods, contains pairs of exterior tabs, interior tabs and bolts connecting the pairs of exterior link plates and interior link plates to each other. The exterior link plates and/or the interior link plates are at least partially made of plastic.

The present invention relates to a chain, particularly a conveyor chain for the transport of chassis carriers or unit loads, as claimed in the preamble of claim 1.

A chain of the aforementioned type is known, for example, in EP 1 645 528 A1. The chain described therein is a roller carrier chain, which can be used for conveying objects. The chain has bushes that are located on the bolts, the rollers being mounted, in their turn, on said bushes. The outer link plates and the inner link plates are produced, as the bolts, the bushes and the rollers, from metal. When heavy objects, such as, for example, chassis carriers (skids) in the automobile industry are to be transported using a chain of this type, the chain and/or the chassis carrier experience a large amount of wear. In addition, slide strips have to be located at the outsides of the chains to reduce the friction of the chains in slide channels. Additionally, as a rule, the bolts and/or the bushes are pressed into the outer link plates and/or the inner link plates, such that an assembly or disassembly of individual link plates involves considerable expenditure.

The problem underlying the present invention is to create a chain of the aforementioned type, which is subject to a smaller amount of wear and/or is constructed in a simpler and/or more cost-efficient manner.

This is achieved as claimed in the invention by a chain of the aforementioned type with the characteristic features of claim 1 or of claim 8. The sub claims relate to preferred developments of the invention.

It is provided as claimed in claim 1 that the outer link plates and/or inner link plates are produced at least partially from plastics material. This type of development makes the chain lighter and more cost-effective. In addition, the plastics material of the chain causes less wear on the chain or the chassis carriers. Depending on the type of plastics material used, said plastics material has such sliding characteristics that make it possible to dispense with lateral sliding elements, in particular slide strips. In addition, the lighter weight of the outer link plates and/or inner link plates that are produced at least partially from plastics material can make them easier to assemble or dismantle.

In addition, it can be provided that the outer link plates and/or the inner link plates are located so as to be moveable on the bolts and that the chain comprises a retaining ring that can be applied on the bolts such that the outer link plates and/or the inner link plates can be easily assembled and/or dismantled.

As claimed in claim 8, it is provided that the chain comprises a plurality of rollers, which protrude beyond the outer link plates and/or inner link plates at least on one side, that the chain does not comprise bushes, in particular not pivot bushes, and that the rollers are located on each or some of the bolts. Dispensing with the bushes that are used in roller carrying chains known in the prior art, on the one hand reduces the weight of the chain and on the other hand reduces the production costs of the chain.

It is possible that, in the case of a chain of this type, the outer link plates and/or the inner link plates are produced in particular from plastics material or also from metal, such as, for example, steel.

It is also possible that the outer link plates and/or the inner link plates are offset, in particular such that outer link plates and inner link plates can be developed in an identical manner. On the one hand this increases the stability of the chain, even though on the other hand, the thickness of the chain in the interconnected state is reduced in the transverse direction because outer link plates and inner link plates interlock in a partial manner. The production costs can be lowered additionally when outer link plates and inner link plates are identical.

It can also be provided that sliding bearings are located on the inside of the rollers, in particular metallic or non metallic sliding bearings, preferably produced from plastics material, or at least one needle bush or at least one ball bearing. This also ensures the rotatability of the rollers where bushes are not provided.

In an advantageous manner, the chain is lubricant-free and/or maintenance-free. This can also be achieved through corresponding characteristics of the plastics material of the outer link plates and/or of the inner link plates.

Further features and advantages of the present invention are made clear by way of the following description of preferred exemplary embodiments with reference to the accompanying figures, in which:

FIG. 1 shows a side view of a chain as claimed in the invention;

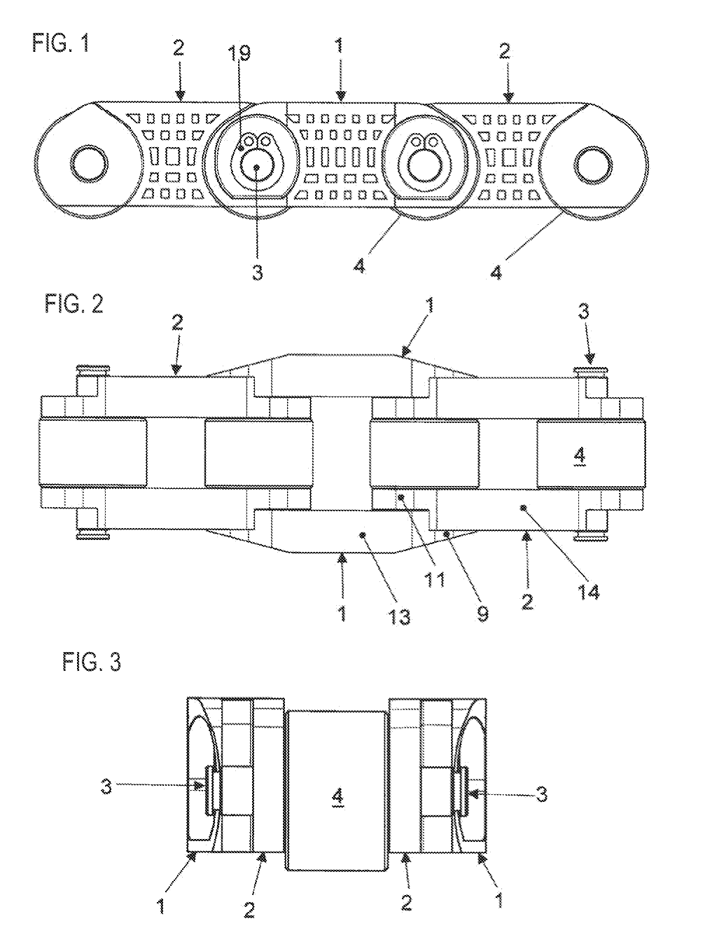

FIG. 2 shows a top view of the chain in FIG. 1;

FIG. 3 shows a front view of the chain in FIG. 1;

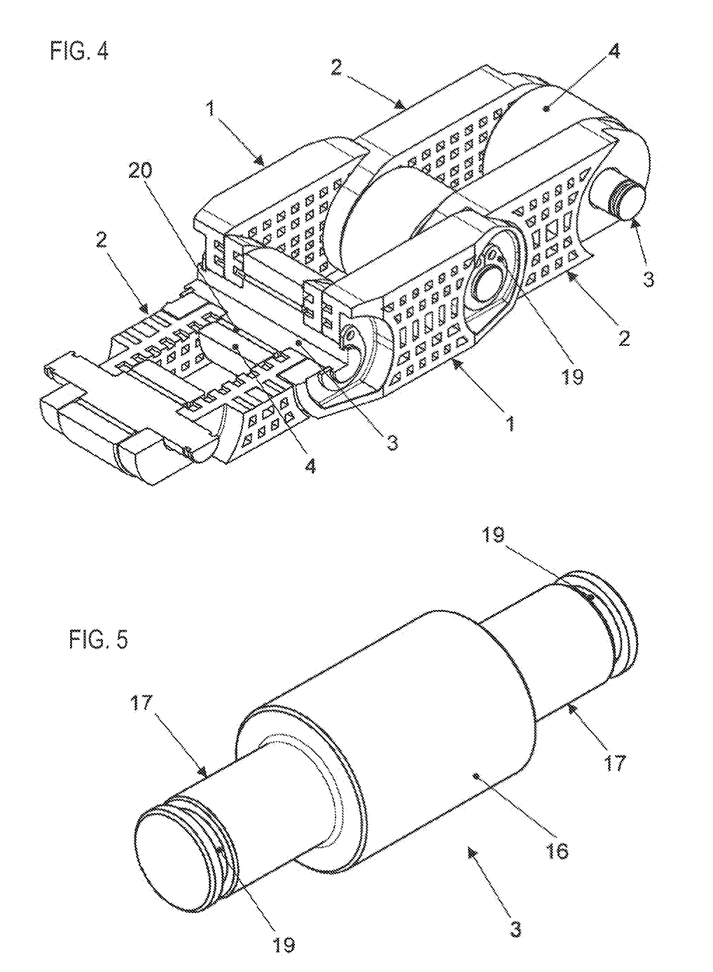

FIG. 4 shows a partially sectional perspective view of the chain in FIG. 1;

FIG. 5 shows a perspective view of a bolt of the chain in FIG. 1;

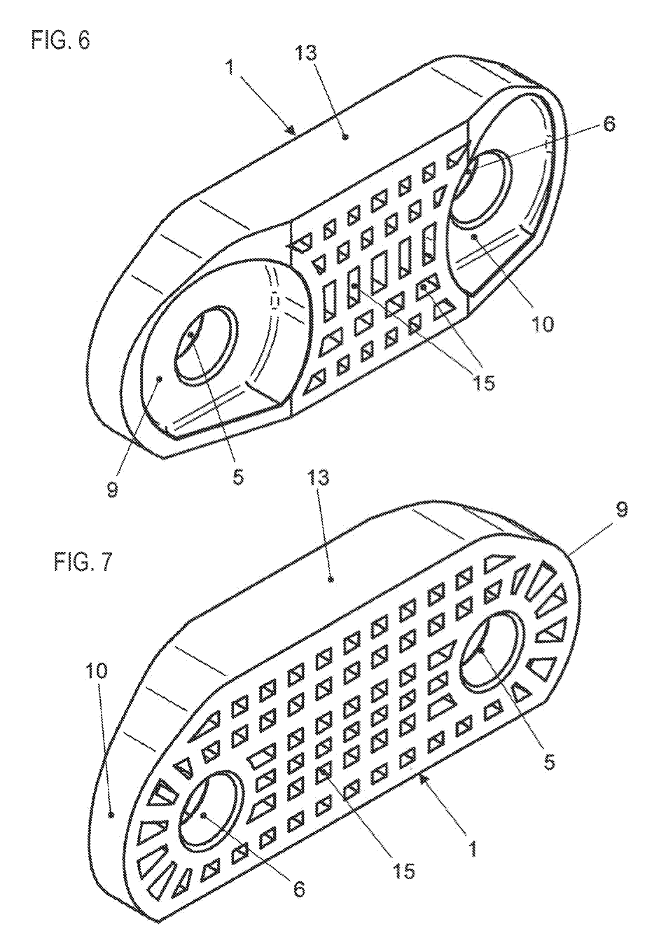

FIG. 6 shows a perspective front view of an outer link plate of the chain in FIG. 1;

FIG. 7 shows a perspective rear view of the outer link plate in FIG. 6;

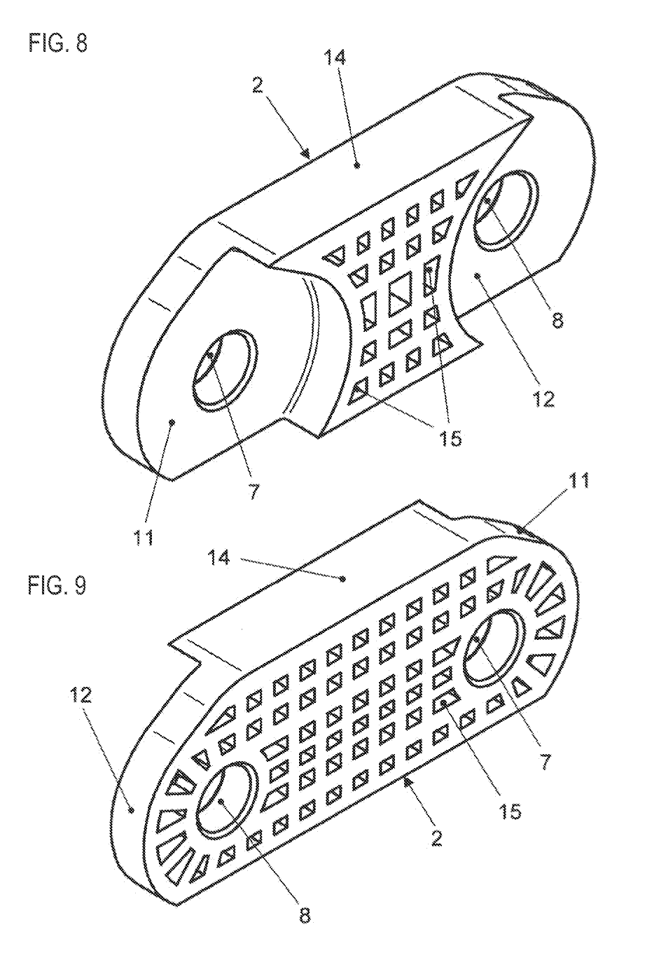

FIG. 8 shows a perspective front view of an inner link plate of the chain in FIG. 1;

FIG. 9 shows a perspective rear view of the inner link plate in FIG. 8.

The embodiment of a chain as claimed in the invention that can be seen in FIG. 1 to FIG. 4 comprises outer link plates 1, inner link plates 2, bolts 3 (see FIG. 3), in each case extending through two outer link plates 1 and two inner link plates 2, as well as rollers 4 located on the bolts 3. In this case, in the position of use the rollers 4 protrude down beyond the outer link plates 1 and the inner link plates 2 (see in particular FIG. 1 and FIG. 3 in this respect). In the longitudinal direction of the chain or from left to right in FIG. 1 and FIG. 2, outer link plates 1 alternate with inner link plates 2 on each side of the chain. In this case, on each of the two sides of the chain a bolt 3 connects an outer link plate 1 to an inner link plate 2. At the same time, each of the bolts 3 connects the left-hand side of the chain in FIG. 3 for example to the right hand side of the chain in FIG. 3.

The outer link plates 1 and the inner link plates 2 can be produced, in particular, from plastics material. Polyoxymethylene (POM) or polyethylene terephthalate (PET) have proven their worth as plastics materials with particularly favorable characteristics with regard to a high level of wear resistance and good sliding characteristics. However, it is quite possible to use other plastics materials. It is also possible to use outer link plates 1 and inner link plates 2 that are produced at least partially from metal.

The outer link plates 1 and inner link plates 2 that can be seen in detail in FIG. 6 to FIG. 9 each have two openings 5, 6, 7, 8, through which the bolts 3 can extend. The outer link plates 1 and the inner link plates 2 are offset, such that the connecting regions 9, 10, 11, 12 surrounding the openings 5, 6, 7, 8 spring back in relation to the central portions 13, 14 of the outer link plates 1 and inner link plates 2. This means that the outer link plates 1 and inner link plates 2, in the interconnected state, take up a comparatively small space in the transverse direction because they interlock in a partial manner. This can be seen in the top view in FIG. 2.

In the case of the embodiment depicted, the outer link plates 1 are formed differently to the inner link plates 2. However, it is quite possible to use identically formed outer link plates 1 and inner link plates 2, such that, on account of the use of just one injection mold, on the one hand production costs and, on the other hand, the storage costs can be reduced.

Both the outer link plates 1 and the inner link plates 2 have a plurality of holes 15, which serve to reduce the weight.

The openings 5, 6, 7, 8 are located in the outer link plates 1 and the inner link plates 2 in an off-centre manner with regard to the vertical direction in the state of use, such that the rollers 4 that are located on the bolts 3 protrude down, not however up, beyond the outer link plates 1 and the inner link plates 2 (see FIG. 1 and FIG. 3 in this respect).

The bolt 3 that can be seen in FIG. 3 can be produced from metal, such as, for example, steel, but can also be produced from plastics material. The bolt 3 has a central portion 16 and two outer portions 17 that are connected thereto. The central portion 16, in this case, has a larger outside diameter than the outer portions 17.

In the interconnected state of the chain, the outer portions 17 extend through the openings 5, 6, 7, 8 in the outer link plates 1 and in the inner link plates 2. In this case, the inside diameter of the openings 5, 6, 7, 8 is somewhat larger than the outside diameter of the outer portions 17, such that the outer link plates 1 and the inner link plates 2 are located loosely on the outer portions 17 of the bolt 3.

A circumferential groove 18 is located in the region of the outer edges of each of the outer portions 17 (see FIG. 5), into which circumferential groove a retaining ring 19 can be inserted to hold the outer link plates 1 and the inner link plates 2 on the bolt 3 (see FIG. 1 and FIG. 4).

The roller 4 can be produced from metal, such as, for example, steel, but also from plastics material. A sliding bearing 20 is located on the inside of the roller 4, it being possible for said sliding bearing to be realized as a metallic or non metallic sliding bearing, preferably produced from plastics material. As an alternative, a needle bush or a ball bearing can also be provided on the inside of the roller 4.

In the case of the chain depicted, the rollers 4 are mounted directly on the bolts 3 by means of the sliding bearings 20. However, it is quite possible to provide bushes (that are not depicted) between the rollers 4 and the bolts 3. In this case, the outside diameter of the central portion 16 of the bolt 3 can then be identical to the outside diameters of the outer sections 17.

1-24. (canceled)

25. A chain, comprising:
pairs of outer link plates and inner link plates, at least one of said outer link plates and said inner link plates are formed at least partially from a plastic material; and
bolts interconnecting said pairs of said outer link plates and said inner link plates.

26. The chain according to claim 25, further comprising a plurality of rollers disposed on at least some of said bolts and protrude beyond at least one of said outer link plates and said inner link plates at least on one side.

27. The chain according to claim 25, further comprising bushes disposed in each case on said bolts.

28. The chain according to claim 26, wherein said rollers are formed from a material selected from the group consisting of plastics, metals, and steel.

29. The chain according to claim 25, wherein said bolts are formed from a material selected from the group consisting of plastics, metals, and steel.

30. The chain according to claim 27, wherein said bushes are formed from a material selected from the group consisting of plastics, metals, and steel.

31. The chain according to claim 27, wherein at least one of said outer link plates and said inner link plates are disposed so as to be moveable on said bolts.

32. The chain according to claim 25, further comprising a plurality of rollers, which protrude beyond at least one of said outer link plates and said inner link plates at least on one side, said rollers are disposed on at least some of said bolts, and the chain does not comprise bushes.

33. The chain according to claim 32, wherein at least one of said outer link plates and said inner link plates are formed from a material selected from the group consisting of plastics, metals and steel.

34. The chain according to claim 32, wherein said rollers are formed from a material selected from the group consisting of plastics, metals and steel.

35. The chain according to claim 32, wherein said bolts are formed from a material selected from the group consisting of plastics, metals and steel.

36. The chain according to claim 32, wherein one of said outer link plates and said inner link plates are secured on said bolts.

37. The chain according to claim 32, wherein at least one of said outer link plates and said inner link plates are disposed so as to be moveable on said bolts.

38. The chain according to claim 25, wherein said bolts have a larger diameter between said inner link plates than in a region of at least one of said outer link plates and said inner link plates.

39. The chain according to claim 25, wherein said bolts have an identical diameter between said inner link plates as in a region of at least one of said outer link plates and said inner link plates.

40. The chain according to claim 25, further comprising sliding bearings disposed on an inside of said rollers.

41. The chain according to claim 25, wherein at least one of said outer link plates and said inner link plates are offset.

42. The chain according to claim 25, wherein the chain is at least one of lubricant-free and maintenance-free.

43. The chain according to claim 25, wherein lateral sliding elements, including slide strips, can be dispensed with because at least one of said outer link plates and said inner link plates are formed from a plastic material.

44. The chain according to claim 25, further comprising a retaining ring applied to said bolts such that at least one of said outer link plates and said inner link plates can be easily assembled and dismantled.

45. The chain according to claim 25, wherein said plastic material of at least one of said outer link plates and said inner link plates has suitable sliding characteristics.

46. The chain according to claim 25, wherein said plastic material of at least one of said outer link plates and said inner link plates is selected from the group consisting of polyoxymethylene (POM) and polyethylene terephthalate (PET).

47. The chain according to claim 25, wherein the chain is configured as a roller carrying chain, and said bolts are disposed on at least one of said outer link plates and said inner link plates in an off-centered manner.

48. The chain according to claim 25, wherein the chain is selected from the group consisting of Galle chains and bush chains.

49. The chain according to claim 25, wherein at least one of said outer link plates and said inner link plates are offset such that said outer link plates and said inner link plate can be developed in an identical manner.

50. The chain according to claim 25, wherein the chain is a conveyor chain for transporting one of chassis carriers and unit loads.

51. The chain according to claim 25, further comprising a plurality of rollers, which protrude beyond at least one of said outer link plates and said inner link plates at least on one side, and said rollers are disposed on at least some of said bolts, and the chain does not comprise pivot bushes.

52. The chain according to claim 40, wherein said sliding bearings are selected from the group consisting of metallic sliding bearings, non metallic sliding bearings, and plastic sliding bearings.

53. The chain according to claim 40, further comprising one of a needle bush and at least one ball bearing disposed on an inside of said rollers.

54. A chain, comprising:
pairs of outer link plates and inner link plates;
bolts interconnecting said pairs of said outer link plates and said inner link plates; and
a plurality of rollers, which protrude beyond at least one of said outer link plates and said inner link plates at least on one side, said rollers disposed on at least some of said bolts, and the chain does not comprise bushes.

55. The chain according to claim 54, wherein at least one of said outer link plates and said inner link plates are formed from a material selected from the group consisting of plastics, metals and steel.

56. The chain according to claim 54, wherein said rollers are formed from a material selected from the group consisting of plastics, metals and steel.

57. The chain according to claim 54, wherein said bolts are formed from a material selected from the group consisting of plastics, metals and steel.

58. The chain according to claim 54, wherein one of said outer link plates and said inner link plates are secured on said bolts.

59. The chain according to claim 54, wherein at least one of said outer link plates and said inner link plates are disposed so as to be moveable on said bolts.
